(19) United States
(12) Patent Application Publication
(10) Pub. No.: US 2007/0200864 A1
(43) Pub. Date: Aug. 30, 2007

(54) Method and system for gathering per-frame image statistics while preserving resolution and runtime performance in a real-time visual simulation

(76) Inventor: Amy Rebecca Tucker, McKinney, TX (US)

Correspondence Address: BAKER BOTTS L.L.P., 2001 ROSS AVENUE, SUITE 600, DALLAS, TX, 75201-2980, US

(21) Appl. No.: 11/365,779

(22) Filed: Feb. 28, 2006

(51) Int. Cl. G09G 5/00

(52) U.S. Cl. 345/582

(57) ABSTRACT

According to various illustrative embodiments of the present invention, a method and system for gathering per-frame image statistics in a real-time visual simulation comprises rendering a scene image in a frame of the real-time visual simulation with contents of a frame buffer copied to a texture comprising a plurality of texels, reducing resolution of the texture comprising the plurality of texels using a vertex shader producing a reduced resolution texture of the scene image, and collecting preliminary data on each texel of the reduced resolution texture of the scene image using a fragment shader operating on a respective fragment. The method also comprises encoding the preliminary data into a plurality of encoded fragments in the frame buffer at each corresponding fragment position, reading the plurality of encoded fragments from the frame buffer using a host application, and calculating the per-frame image statistics desired for the scene image in the frame of the real-time visual simulation using the host application.

### TECHNICAL FIELD OF THE INVENTION

This invention relates generally to the field of computer graphics and, more particularly, to a method for gathering per-frame image statistics while preserving resolution and runtime performance in a real-time visual simulation.

### BACKGROUND OF THE INVENTION

In real-time visual simulation where certain camera and/or sensor effects are required, some effects, such as automatic gain control, require accurate image statistics as inputs to perform correctly. For example, conventional attempts to provide real-time automatic gain control for night vision goggle (NVG) simulation have never performed at an acceptable speed and are rarely if ever used. Performance has been hindered by the fact that data from the image's histogram is needed on a per-frame basis to drive the gain effect up or down as needed, and this data can only be collected by analyzing each pixel of every frame. For example, the effect may have to run at 60 frames per second, where the size of each frame may be 806×806 pixels. Even on conventional systems that had used the OpenGL Histogram extension (GL_HISTOGRAM), for example, to improve the speed at which the necessary data was collected, the performance never improved to an acceptable level, particularly at the larger frame size required.

### SUMMARY OF THE INVENTION

According to various illustrative embodiments of the present invention, a method and system for gathering per-frame image statistics in a real-time visual simulation comprises rendering a scene image in a frame of the real-time visual simulation with contents of a frame buffer copied to a texture comprising a plurality of texels, reducing resolution of the texture comprising the plurality of texels using a vertex shader producing a reduced resolution texture of the scene image, and collecting preliminary data on each texel of the reduced resolution texture of the scene image using a fragment shader operating on a respective fragment. The method also comprises encoding the preliminary data into a plurality of encoded fragments in the frame buffer at each corresponding fragment position, reading the plurality of encoded fragments from the frame buffer using a host application, and calculating the per-frame image statistics desired for the scene image in the frame of the real-time visual simulation using the host application.

Various embodiments of the present invention may benefit from numerous advantages. It should be noted that one or more embodiments may benefit from some, none, or all of the advantages discussed below. The system and method disclosed herein are advantageous in solving the performance problems of conventional systems and methods that attempt to provide real-time visual simulation where certain camera and/or sensor effects are required that need accurate image statistics as input to perform correctly, while maintaining acceptable image resolution. The system and method disclosed herein, by utilizing a fragment shader to collect more specific image data in only one rendering pass, are further advantageous in showing greater performance and better accuracy than conventional systems and methods that must necessarily use multiple rendering passes. The system and method disclosed herein are still further advantageous in improving the performance of business critical applications and, hence, in improving the user and/or customer experience. Other technical advantages will be apparent to those of ordinary skill in the art having the benefit of the present disclosure and in view of the following specification, claims, and drawings.

### BRIEF DESCRIPTION OF THE DRAWINGS

For a more complete understanding of the present invention and its advantages, reference is now made to the following description, taken in conjunction with the accompanying drawings, in which:

FIG. 1 illustrates one embodiment of a computer system capable of gathering per-frame image statistics in a real-time visual simulation, according to teachings of the present disclosure;

FIG. 2 illustrates one embodiment of a scene image in a frame of a real-time visual simulation;

FIG. 3 illustrates the scene image shown in FIG. 2 rendered with the frame buffer contents copied to a texture that has been applied to a polygonal quad;

FIG. 4 illustrates one embodiment of the texture that is divided into nine sections;

FIG. 5 illustrates another embodiment of the scene image shown in FIG. 2;

FIG. 6 illustrates one embodiment of nine texels used to perform the nine lookups into each of the nine sections shown in FIG. 4;

FIG. 7 illustrates an example of three different statistics collected in one pass for a red, green, blue (RGB) configuration and then encoded into the resulting fragment;

FIG. 8 illustrates other exemplary embodiments of how a histogram may be analyzed, according to teachings of the present disclosure; and

FIG. 9 illustrates a method for gathering per-frame image statistics in a real-time visual simulation, according to teachings of the present disclosure.

It is to be noted, however, that the appended drawings illustrate only particular embodiments of the present invention and are, therefore, not to be considered limiting of the scope of the present invention, as the present invention may admit to other equally effective embodiments.

### DETAILED DESCRIPTION OF ILLUSTRATIVE EMBODIMENTS OF THE INVENTION

Illustrative embodiments of the present invention are described in detail below. In various illustrative embodiments, a method and system for gathering per-frame image statistics in a real-time visual simulation may be provided, enabling per-frame statistics to be gathered quickly and accurately, for example, as described in more detail below. Computer graphics may render a scene image, comprising a plurality of pixels (picture elements), in a frame of the real-time visual simulation by having the contents of a frame buffer holding the plurality of pixels be copied to a texture comprising a plurality of texels (texture elements). Textures may be produced by texture filtering and/or texture mapping. For example, a brick texture may be applied to respective faces of a polygonal shape representing a building to render a brick building scene image in a frame of a real-time visual simulation in computer graphics. Similarly, a texture depicting the geography of the surface of the Earth may be applied to a polygonal shape representing a sphere to render a representation of the Earth, for example. In various illustrative embodiments, some pixel information in the original scene image may be lost in the process of rendering the scene image into a corresponding texture.

By further reducing the resolution of the corresponding texture representative of the scene image in the frame of the real-time visual simulation, using a vertex shader provided on a graphics card, and then dividing the statistical analysis between a fragment shader provided on the graphics card and a host application capable of displaying the real-time visual simulation, for example, the processing burden may be reduced and performance may be maintained and/or enhanced. Various illustrative embodiments may be readily adapted for different hardware configurations and/or different application requirements. Also, by manipulating the size of the small quad and/or polygonal shape(s) used to render the texture in the vertex shader and/or the number of texture lookups in the fragment shader, resolution may be favored over speed, or, alternatively, speed may be favored over resolution, as needed and/or desired.

In various illustrative embodiments, fragment or pixel data may be collected in the graphics pipeline itself and the performance of OpenGL's Imaging Subset may be improved in several significant ways, by reducing the resolution to a workable size before processing, and by passing the more intensive statistical analysis back to the host application where, as long as the resolution is adequately reduced, the intensive statistical analysis can be handled more efficiently. The resolution may be manipulated within the graphics pipeline by calculating new texture coordinates in the vertex shader that may effectively shrink the image to cover a smaller area of the frame. Then, the resulting smaller image may be processed in the fragment shader where very simple statistics at each fragment or pixel position may be collected. The results may then be written directly to the frame buffer at the same resolution for capture by the host application, which only has to process a small number of fragments or pixels instead of the full image.

To accomplish this using OpenGL's Imaging Subset, an image much smaller than the size of the frame may be needed to maintain performance. Shrinking the frame to a workable size for either the GL_HISTOGRAM and/or the GL_MINMAX extensions of OpenGL's Imaging Subset may result in an unacceptable loss in resolution, where certain smaller areas that should contribute to image statistics are often lost. In various illustrative embodiments, the vertex shader may decrease the resolution of the frame but may limit this decrease by dividing the frame into a plurality of areas, such as nine areas, for example, and by effectively layering those areas on top of each other, so that the smaller processed area actually represents an image many times its size, such as nine times its size, for example. The fragment shader may then make a plurality of comparisons per fragment or pixel (one for each layer), such as nine comparisons per fragment or pixel (one for each layer), for example, and may encode the results back into the frame buffer at the corresponding fragment positions. Finally, the host application may capture this data and may make the necessary comparisons among all fragments or pixels to get the final per-image statistics, which is something fragment shaders are, by design, unable to do, and which appears to be a bottleneck in the conventional use of OpenGL's Imaging Subset. Fragment shaders, by design, may make a plurality of comparisons per fragment or pixel (one for each layer), for example, but are unable to make comparisons between and/or among neighboring fragments or pixels.

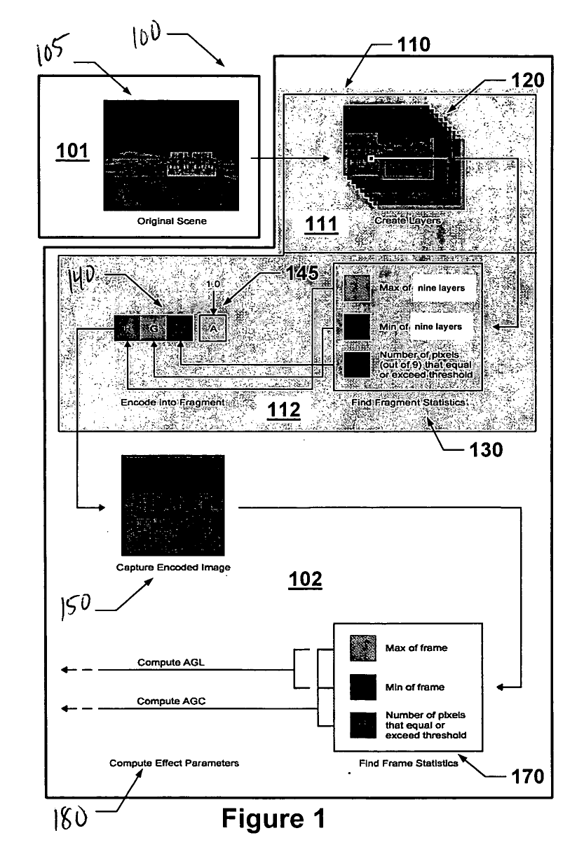

FIG. 1 illustrates various exemplary embodiments of a computer system 100 capable of gathering per-frame image statistics in a real-time visual simulation, showing, for example, how a histogram may be analyzed, according to teachings of the present disclosure. The computer system 100 may comprise an information storage system 101 comprising at least one memory capable of storing a plurality of frames of the real-time visual simulation and an information processing system 102 capable of performing a method for gathering per-frame image statistics in the real-time visual simulation. The information storage system 101 may store an original scene image 105 in a frame of the real-time visual simulation, for example. The information processing system 102 may comprise hardware shaders 110, including a vertex shader component 111 and a fragment shader component 112, for example. One of ordinary skill in the art, having the benefit of the present disclosure, would understand that the information storage system 101 may be disposed as part of the information processing system 102, for example, in various illustrative embodiments.

The original scene image 105 in the frame of the real-time visual simulation may be passed to the hardware shaders 110, as described in more detail below. The hardware shaders 110 may be disposed on one or more graphics cards, for example. The vertex shader component 111 of the hardware shaders 110 may then create a plurality of texture layers 120, as described in more detail below. The fragment shader component 112 of the hardware shaders 110 may then find fragment statistics, as indicated at 130 and as described in more detail below. For example, the vertex shader 111 may then pass nine sets of coordinates (one set for each of nine texture layers 120) to the fragment shader 112, which may process the texture as if the texture were nine separate levels of imagery. If the purpose of analyzing the histogram is to find the minimum and maximum intensities, for example, then a preliminary comparison may be done per fragment that compares the values at the current coordinates in each of the nine texture layers 120. This may produce nine different values, from which a minimum intensity value and a maximum intensity value may be found. The maximum intensity value may then be stored in the fragment's red color component, while the minimum intensity value may then be stored in the fragment's green color component, for example, as indicated at 140.

A third statistic may be calculated that represents the percentage of coverage of all intensities that equal or exceed a user-specified and/or predetermined threshold value. The fragment shader 112 may count how many of the nine intensity values for each of the nine texture layers 120 meet the criteria, and the normalized count may then be stored in the fragment's blue component, for example, as indicated at 140.

After each fragment is encoded with the necessary statistics and the small channel is rendered, a postDraw( ) subscriber, running on the information processing system 102, for example, may capture the frame for further analysis, as indicated at 150. Using the information processing system 102, for example, each fragment/pixel may be visited in a loop to find the frame's maximum and minimum intensities, as well as a total count of how many fragments/pixels were equal to or brighter than the threshold. All three fragment/pixel color components may be analyzed in each iteration of the loop, as indicated at 170.

At the end of this process, the frame's minimum and maximum intensities may have been found, as well as the total number of pixels that equal or exceed a user-specified threshold, as indicated at 170, for example. These values may then be used by the information processing system 102 to calculate the appropriate amount of applied gain and/or applied level, as indicated at 180, for example. FIG. 1 shows an example process used to analyze the histogram. The creation of the texture layers 120, the finding of the fragment statistics 130, and the encoding into the fragment 140 may all occur within the hardware shaders 110, the vertex shader 111 and/or the fragment shader 112 used as appropriate, whereas all the other processes of capturing the encoded image 150, optionally blurring each channel 160 (not shown), and finding the per-frame statistics 170 may be completed in the appropriate host application and/or host applications running in and/or on the information processing system 102.

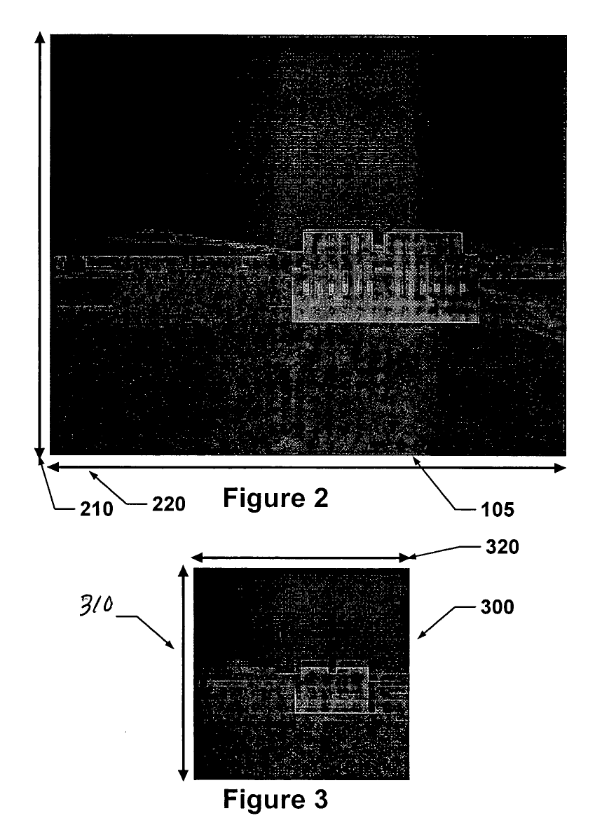

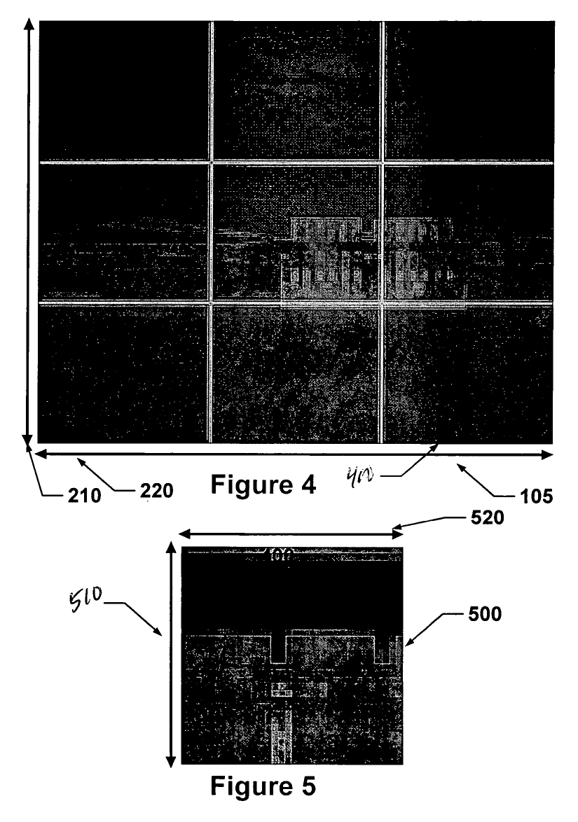

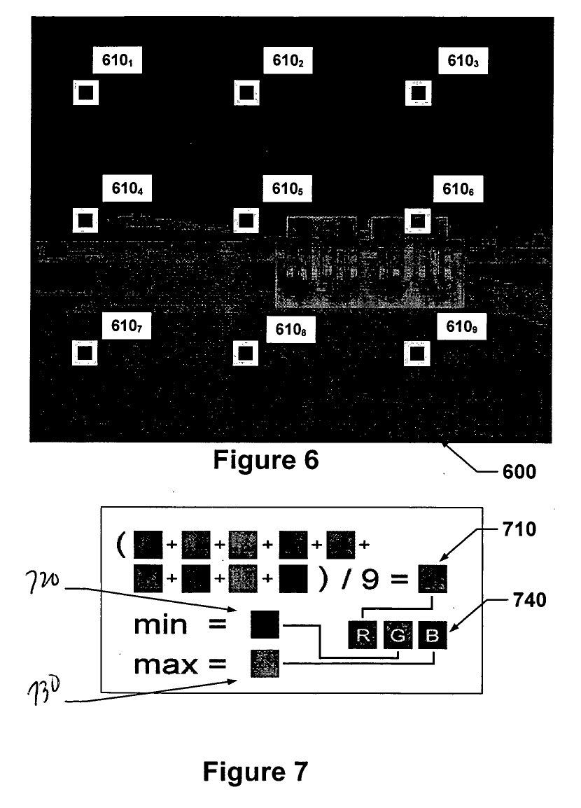

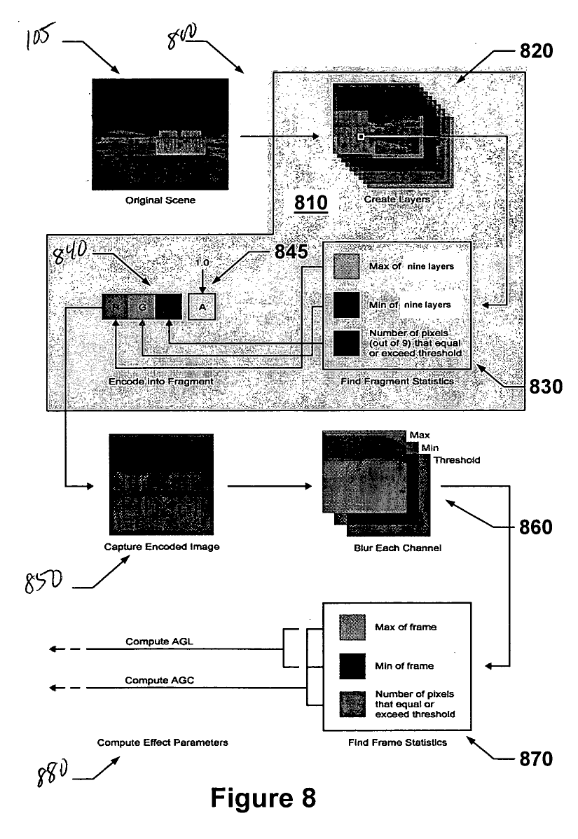

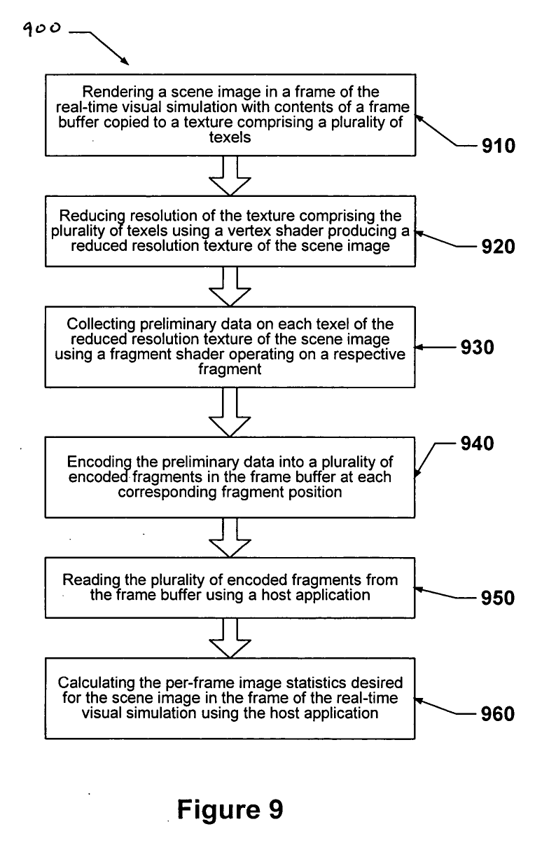

In various illustrative embodiments, a method for gathering per-frame image statistics in a real-time visual simulation may include rendering a scene image in a frame of the real-time visual simulation normally, as shown in FIGS. 2 and 4, for example, with contents of a frame buffer copied to a texture, reducing resolution of the texture using a vertex shader, as shown in FIG. 5, for example, and collecting preliminary data on each pixel of the scene image using a fragment shader, as shown in FIG. 6, for example. The method may also include encoding the results of collecting the preliminary data on each pixel of the scene image using the fragment shader into the frame buffer at each corresponding position, as shown in FIG. 7, for example, reading the resulting pixels from the frame buffer using a host application, as shown in FIG. 8, for example, and calculating the per-frame image statistics desired for the scene image in the frame of the real-time visual simulation using the host application, as shown in FIG. 9, for example.

In various illustrative embodiments, methods for collecting per-frame image statistics in a real-time visual simulation while maintaining performance and adequate image resolution may be provided, as shown in FIGS. 1 and 8, for example. Various illustrative embodiments may utilize hardware shader technology to collect image statistics such as minimum and maximum color intensities, average brightness, and other statistics independent of pixel location, from a rendered scene image on a per-frame basis. To avoid the impact on performance caused by conventional per-pixel operations, each pixel of the frame may be analyzed in a fragment shader, and the results may then be encoded in the separate color channels of the frame buffer for readback and use by the runtime host application, as shown in FIGS. 1 and 6-8, for example. Because a fragment shader performs operations on one fragment at a time with no knowledge of that fragment's neighbors, it may be useful to encode intermediate results directly to the frame buffer for final processing by the host application, as shown in FIGS. 1 and 8, for example. Various illustrative embodiments may further minimize the impact on performance by processing an area that is significantly smaller than the actual image, thereby reducing the number of pixel operations performed as well as the time it takes to perform the readback. However, instead of merely shrinking the image to a workable size and subsequently losing valuable details that need to be processed, resolution may be preserved by dividing the image into substantially equal-sized sections and then overlapping the substantially equal-sized sections, as shown in FIGS. 1 and 4-8, for example. The fragment shader then processes the smaller image by analyzing the corresponding values in each layer and tallying the results for each fragment, as shown in FIGS. 1, 7 and 8, for example.

Whole image statistics collection is an inherently slow process, even with OpenGL extension support. Whole image statistics collection may require analysis of every pixel and must be able to keep a running tally of the data. Fragment shaders are one choice for a process that visits each pixel on a per-frame basis, but data may not be able to be retained from one pixel to the next by a fragment shader. When the fragment shader is called, the fragment shader only has knowledge of the one pixel, or fragment, that the fragment shader is processing at that time. Consequently, in various illustrative embodiments, data analysis may be shared between the fragment shader and the host application.

Various illustrative embodiments of methods for collecting image statistics may be described in several stages. First, a scene image 105, as shown in FIGS. 1 and 2, for example, may be rendered to a texture, which may comprise a plurality of texels, and a vertex shader may be used to reduce the texture's resolution and prepare it for processing, as shown in FIGS. 1 and 5, for example. Next, the fragment shader may collect preliminary data on each pixel and may encode the results back into the frame buffer at each corresponding position, as shown in FIGS. 1, 7, and 8, for example. Finally, the host application may read the resulting pixels from the frame buffer and may calculate the desired statistics for the entire image, as shown in FIGS. 1 and 8, for example.

Referring first to FIG. 2, the scene image 105 may be rendered normally and the frame buffer contents may be copied to a texture. In various illustrative embodiments, the texture may comprise a plurality of texels, for example. In various illustrative embodiments, the scene image 105 may be about 500 pixels by about 600 pixels, for example, as indicated by arrows 210 and 220, respectively. This texture may be applied to a polygonal quad that is just small enough to be captured and processed by the host application in a later stage without substantially hindering performance. In various illustrative embodiments, hardware shaders may be used to prepare the scene image 105 in such a way that histogram data may be collected and processed as quickly as possible. During configuration, a small channel may be created and placed behind all other channels in the application window, for example. As shown in FIGS. 3 and 5, for example, this channel may not exceed about 32 pixels by about 32 pixels in size, as indicated by arrows 310 and 320, and 510 and 520, respectively, because this may be the number of pixels that may be processed per frame by the host application. A polygon may then be drawn over the channel, which displays a texture representing the raw scene image 105, such as a raw infrared (IR) scene image. This texture may be created by subloading imagery directly from the frame buffer before any other effects are applied, so that no other effects may be reproduced in the histogram.

Because the texture is significantly larger than the polygon that displays the texture, a vertex shader may be applied to the polygon that will reduce resolution while substantially minimizing loss of detail. By way of contrast, FIG. 3 schematically illustrates the scene image 105 shown in FIGS. 1 and 2 rendered normally, with the frame buffer contents copied to a texture that has been applied to the polygonal quad that is just small enough to be captured and processed by the host application in a later stage without substantially hindering performance, but without any manipulation by a vertex shader having been applied to the polygon that would have reduced resolution while substantially minimizing loss of detail. FIG. 3 shows how much detail can be lost when the texture is reduced to fit the small quad without any manipulation by a vertex shader.

FIG. 4 illustrates how much more detail is retained when the texture is divided into nine sections 400 and the texture coordinates are calculated within the vertex shader as if the texture were separated into the nine sections 400, allowing the fragment shader to perform nine different lookups per pixel into the same texture as if each of the nine sections 400 were a separate image layer, as shown in FIGS. 1 and 8, for example. FIG. 5 schematically illustrates the scene image 105 shown in FIGS. 1 and 2 rendered normally with the frame buffer contents copied to a texture that has been applied to the polygonal quad that is just small enough to be captured and processed by the host application in a later stage without substantially hindering performance, and with manipulation by the vertex shader having been applied to the polygon that may reduce resolution while substantially minimizing loss of detail, as indicated at 500, with each of the nine sections 400 having being applied to the polygon as if it were a separate texture layer, showing the size and detail of the building, although overlapped, by way of contrast to the image shown in FIG. 3. As shown in FIGS. 1, 4, 5, and 8, more detail is retained by calculating texture coordinates within the vertex shader as if the texture were separated into the nine sections 400. This allows the fragment shader to perform the nine different lookups per pixel into the same texture as if each of the nine sections 400 were a separate image layer, as shown in FIGS. 1 and 8, for example.

In various illustrative embodiments, certain hardware configurations may call for fewer divisions 400 of the scene image 105 (i.e., fewer texture lookups) to maintain a desired level of performance. Conversely, in various alternative illustrative embodiments, some different hardware configurations may be able to handle more than nine divisions 400 of the scene image 105 and, consequently, more than nine texture lookups without a substantial loss in performance, preserving even more resolution. As persons having ordinary skill in the art would recognize, having the benefit of the present disclosure, it may be left to the user to adapt various illustrative embodiments according to available hardware features and/or specific application requirements.

FIG. 6 schematically illustrates a texture 600 having nine texels 610₁, 610₂, 610₃, . . . , 610₉, for example, which may be used to perform the nine lookups into each of the nine sections 400 shown in FIG. 4. FIG. 7 schematically illustrates an example of three different statistics collected in one pass for a red, green, blue (RGB) color configuration and then encoded into the resulting fragment. The fragment shader may receive nine sets of texture coordinates from the vertex shader, corresponding to the nine texels 610₁, 610₂, 610₃, . . . , 610₉, for example, which the fragment shader may use to perform nine lookups at different locations within the same texture 600. The fragment shader then may make comparisons among the nine values and write the results directly to the frame buffer using one or all available color components 740 as necessary, such as one or more of the red, green, and/or blue color components 740 of an RGB configuration. For example, if average image brightness were needed, the fragment shader may find the brightness of each of the nine texels 610₁, 610₂, 610₃, . . . , 610₉, for example, average the values together and store the result 710 in the red component of its resulting fragment, as shown schematically in FIG. 7. If minimum 720 and maximum 730 intensities were also needed, these statistics may be calculated from the same nine texels 610₁, 610₂, 610₃, . . . 610₉, for example, and stored in the green and blue components 740, as shown schematically in FIG. 7. In this way, multiple statistical processes, as many as the user's frame buffer configuration may allow, may be consolidated into one pass, as shown schematically in FIG. 7.

In various illustrative embodiments, nine values may be obtained by performing lookups into each of the nine sections 400 of the texture 600, as shown in FIG. 6, for example. For an RGB configuration, up to three different statistics may be collected in one pass, and then encoded into the resulting fragment 740, as shown in FIG. 7, for example. In various illustrative embodiments, other statistical measures may be collected in one pass, and then encoded into the resulting fragment. For an RGB configuration, for example, a simplified histogram for three intensity ranges may be collected and/or highlights, midtones, and shadows may be collected and/or the separate intensities of red, blue, and green may be collected and/or the average brightness, maximum intensity, and minimum intensity may be collected, as shown in FIG. 7, and/or any appropriate and/or desired combination of any three of the foregoing statistical measures may be collected in one pass, and then encoded into the resulting fragment.

For example, choosing three statistical measures from among a dozen including a simplified histogram for three intensity ranges, highlights, midtones, shadows, the separate intensities of red, blue, and green, and the average brightness, maximum intensity, and minimum intensity may result in about 220 different combinations of statistical measures, without regard to their particular order, that may be collected in one pass, and then encoded into the resulting fragment. More generally, choosing r statistical measures from among n possible statistical measures may result in about

$$( \begin{matrix}n \\ r\end{matrix} ) = \frac{n !}{r ! ( n - r ) !}$$

different combinations of statistical measures, without regard to their particular order, where n!=n(n−1)(n−2) . . . (3)(2)(1) and r≦n (with 0!=1), that may be collected in one pass, and then encoded into the resulting fragment, writing the results directly to the frame buffer using all r available color components. When r=3 and n=12, for example, there are

$$( \begin{matrix}12 \\ 3\end{matrix} ) = \frac{12 !}{3 ! ( 12 - 3 ) !} = \frac{12 !}{3 ! ( 9 ) !} = \frac{( 12 ) ( 11 ) ( 10 )}{( 3 ) ( 2 ) ( 1 )} = 220$$

different combinations of statistical measures, without regard to their particular order, as described above.

In various illustrative embodiments, after each fragment is encoded with the necessary statistics and the small quad 500 is rendered, the host application may capture the area into a main memory, as indicated at 150 of FIG. 1, and as indicated at 850 of FIG. 8, for example. Next, each pixel of the captured area may be visited in a loop, where all of the color components may be analyzed in each loop iteration. As shown in FIG. 5, for example, the captured area may be about 32 pixels by about 32 pixels in size, as indicated by the arrows 510 and 520, respectively, so that about 32²=1024 loop visitations may be involved, with about 3×32²=3×1024=3072 total color components analyzed for the RGB configuration where all three color components are analyzed each loop iteration. In various illustrative embodiments, where the captured area may be about p pixels by about q pixels in size, about pq loop visitations may be involved, with about rpq total color components analyzed for the configuration where all r available color components are analyzed each loop iteration.

Unlike a fragment shader, the host application may track and store any variables needed for whole image analysis. Running totals may be maintained, and/or comparisons that determine minimum and maximum values may be made readily. The output of this final process may be a set of statistics that pertain to the entire scene image 105 and that may then be used to drive one or more other functions within the application, as indicated at 180 of FIG. 1, and as indicated at 880 of FIG. 8, for example, and/or may be passed directly to the user.

FIG. 8 schematically illustrates at 800 other exemplary embodiments of how a histogram may be analyzed, according to teachings of the present disclosure. The original scene image 105 may be passed to hardware shaders 810, as described above. A vertex shader component of the hardware shaders 810 may then create a plurality of texture layers 820, as described above. A fragment shader may then find fragment statistics, as indicated at 830 and as described above. For example, the vertex shader may then pass nine sets of coordinates (one set for each of nine texture layers 820) to the fragment shader, which may process the texture as if the texture were nine separate levels of imagery. If the purpose of analyzing the histogram is to find the minimum and maximum intensities, for example, then a preliminary comparison may be done per fragment that compares the values at the current coordinates in each of the nine texture layers 820. This may produce nine different values, from which a minimum intensity value and a maximum intensity value may be found. The maximum intensity value may then be stored in the fragment's red component, while the minimum intensity value may then be stored in the fragment's green component, for example, as indicated at 840.

A third statistic may be calculated that represents the percentage of coverage of all intensities that equal or exceed a user-specified and/or predetermined threshold value. The fragment shader may count how many of the nine intensity values for each of the nine texture layers 820 meet the criteria, and the normalized count may then be stored in the fragment's blue component, for example, as indicated at 840.

After each fragment is encoded with the necessary statistics and the small channel is rendered, a postDraw( ) subscriber, for example, may capture the frame for further analysis, as indicated at 850. Each fragment/pixel may be visited in a loop to find the frame's maximum and minimum intensities, as well as a total count of how many fragments/pixels were equal to or brighter than the threshold. All three fragment/pixel color components may be analyzed each loop iteration, as indicated at 870.

Although layering may substantially diminish minification errors, problems may still exist and cause fluctuations in the histogram data, in various illustrative embodiments. A scene containing a starlit sky may be a good example. A star image may consist of very few pixels, sometimes no more than one pixel. As the eye point moves across the scene, some of the stars in the unfiltered, shrunken texture may disappear and reappear, causing fluctuations in the maximum intensity between frames. This may also apply to light points and any small details of minimum and/or maximum intensity. When the dynamic range of the image fluctuates, the applied gain and level may fluctuate as well, creating an undesirable flickering effect.

To alleviate this problem, in various illustrative embodiments, the captured image 850 may optionally be blurred, as indicated at 860, for example, as the captured image 850 is processed. For simplicity, only the inner 31×31 pixel area may be used, for example, saving the outer edges for averaging purposes only. For example, as the red component is processed, a lookup may be done into the pixel's eight neighbors and all nine red components may be averaged and compared with the current maximum value. The same may be done with the green component for the minimum value, and the blue component for the threshold count. This averaging may substantially eliminate most unwanted flicker. This averaging may also ignore small bright spots such as stars and/or distant light points, which should have little to no effect on the applied gain and level calculations, for example.

There are at least two reasons why such an approach may be better than a shader-based blur before statistics encoding. First, since the shader has no knowledge of its fragment's neighbors, the resulting components may not be able to be averaged. The only alternative may be to perform a blur on each of the nine layers of the texture as each lookup is performed. However, even with a “fast” blur, five texture lookups may have to be made per layer, which may substantially hinder performance. Second, the fragment shader would blur the data too early in the process. The resolution of the texture input may equal the resolution of the frame from which the texture input was captured, so there may be no minification errors to correct at this stage. Consequently, optionally averaging the data after the capture may be a better option, as indicated at 860.

At the end of this process, the frame's minimum and maximum intensities may have been found, as well as the total number of pixels that equal or exceed a user-specified threshold, as indicated at 870, for example. These values may then be used to calculate the appropriate amount of applied gain and/or applied level, as indicated at 880, for example. FIG. 8 shows the entire process used to analyze the histogram, according to various illustrative embodiment and as described above in the present disclosure. The creation of the texture layers 820, the finding of the fragment statistics 830, and the encoding into the fragment 840 may all occur within the hardware shaders 810, the vertex shader and/or the fragment shader used as appropriate, whereas all the other processes of capturing the encoded image 850, optionally blurring each channel 860, and finding the per-frame statistics 870 may be completed in the appropriate host application and/or host applications.

In various illustrative embodiments, as shown in FIG. 9, a method 900 for gathering per-frame image statistics in a real-time visual simulation may be provided. The method 900 may comprise rendering a scene image in a frame of the real-time visual simulation with contents of a frame buffer copied to a texture comprising a plurality of texels, as indicated at 910, reducing resolution of the texture comprising the plurality of texels using a vertex shader producing a reduced resolution texture of the scene image, as indicated at 920, and collecting preliminary data on each texel of the reduced resolution texture of the scene image using a fragment shader operating on a respective fragment, as indicated at 930. The method 900 may also comprise encoding the preliminary data into a plurality of encoded fragments in the frame buffer at each corresponding fragment position, as indicated at 940, reading the plurality of encoded fragments from the frame buffer using a host application, as indicated at 950, and calculating the per-frame image statistics desired for the scene image in the frame of the real-time visual simulation using the host application, as indicated at 960.

In various illustrative embodiments, per-frame statistics may be gathered quickly and accurately, as described above. By reducing resolution and then dividing the analysis between the fragment shader and the host application, for example, the processing burden may be reduced and performance may be maintained. Various illustrative embodiments may be readily adapted for different hardware configurations and/or different application requirements. Also, by manipulating the size of the small quad and/or the number of texture lookups in the fragment shader, resolution may be favored over speed, or, alternatively, speed may be favored over resolution, as needed and/or desired.

In various illustrative embodiments, pixel data may be collected in the graphics pipeline itself and the performance of OpenGL's Imaging Subset may be improved in several significant ways, by reducing the resolution to a workable size before processing, and by passing the more intensive analysis back to the host application where, as long as the resolution is adequately reduced, the intensive analysis can be handled more efficiently. The resolution may be manipulated within the pipeline by calculating new texture coordinates in a vertex shader that may effectively shrink the image to cover a smaller area of the frame. Then, the resulting smaller image may be processed in a fragment shader where very simple statistics at each pixel position may be collected. The results may then be written directly to the frame buffer at the same resolution for capture by the host application, which only has to process a small number of pixels instead of the full image.

To accomplish this using OpenGL's Imaging Subset, an image much smaller than the size of the frame may be needed to maintain performance. Shrinking the frame to a workable size for either the GL_HISTOGRAM and/or the GL_MINMAX extensions of OpenGL's Imaging Subset may result in an unacceptable loss in resolution, where certain smaller areas that should contribute to image statistics are often lost. In various illustrative embodiments, the vertex shader may decrease the resolution of the frame but may limit this decrease by dividing the frame into a plurality of areas, such as nine areas, for example, and by effectively layering those areas on top of each other, so that the smaller processed area actually represents an image many times its size, such as nine times its size, for example. The fragment shader may then make a plurality of comparisons per pixel (one for each layer), such as nine comparisons per pixel (one for each layer), for example, and may encode the results back into the frame buffer at their corresponding positions. Finally, the host application may capture this data and may make the necessary comparisons among all pixels to get the final per-image statistics, which is something fragment shaders are, by design, unable to do, and which appears to be the bottleneck in the conventional use of OpenGL's Imaging Subset.

As described above, the system and method disclosed herein are advantageous in solving the performance problems of conventional systems and methods that attempt to provide real-time visual simulation where certain camera and/or sensor effects are required that need accurate image statistics as input to perform correctly, while maintaining acceptable image resolution. The system and method disclosed herein, by utilizing a fragment shader to collect more specific image data in only one rendering pass, are further advantageous in showing greater performance and better accuracy than conventional systems and methods that must necessarily use multiple rendering passes. The system and method disclosed herein are still further advantageous in improving the performance of business critical applications deployed on clustering systems and, hence, in improving the user and/or customer experience.

The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention.

Although various illustrative embodiments of the present invention and their advantages are described in detail, a person skilled in the art having the benefit of the present disclosure could make various alterations, additions, and/or omissions without departing from the spirit and scope of the present invention, as defined by the appended claims.

What is claimed is:

1. A method for gathering per-frame image statistics in a real-time visual simulation, the method comprising:
rendering a scene image in a frame of the real-time visual simulation with contents of a frame buffer copied to a texture comprising a plurality of texels;
reducing resolution of the texture comprising the plurality of texels using a vertex shader producing a reduced resolution texture of the scene image;
collecting preliminary data on each texel of the reduced resolution texture of the scene image using a fragment shader operating on a respective fragment;
encoding the preliminary data into a plurality of encoded fragments in the frame buffer at each corresponding fragment position;
reading the plurality of encoded fragments from the frame buffer using a host application; and
calculating the per-frame image statistics desired for the scene image in the frame of the real-time visual simulation using the host application.

2. The method of claim 1, wherein rendering the scene image in the frame of the real-time visual simulation with contents of the frame buffer copied to the texture comprising the plurality of texels further comprises applying the texture to a polygon quad capable of being captured and processed by the host application, and wherein reducing the resolution of the texture comprising the plurality of texels using the vertex shader producing the reduced resolution texture of the scene image further comprises calculating texture coordinates within the vertex shader as if the texture were separated into a plurality of sections, allowing the fragment shader to perform a plurality of different lookups into the texture for each fragment of the reduced resolution texture of the scene image as if each section of the plurality of sections were a separate image layer of the reduced resolution texture of the scene image.

3. The method of claim 1, wherein collecting the preliminary data on each texel of the reduced resolution texture using the fragment shader further comprises having the fragment shader receive a plurality of sets of texture coordinates from the vertex shader, performing a plurality of lookups at different locations within the texture corresponding to the plurality of the sets of the texture coordinates received from the vertex shader, and making at least one comparison among values gathered from the plurality of the lookups and at least one statistical calculation using the values gathered from the plurality of the lookups, and wherein encoding the preliminary data into the plurality of encoded fragments in the frame buffer at each corresponding fragment position further comprises writing the preliminary data directly into the plurality of encoded fragments in the frame buffer at each corresponding fragment position using at least one available color component of a configuration of the frame buffer in one pass.

4. The method of claim 2, wherein collecting the preliminary data on each texel of the reduced resolution texture using the fragment shader further comprises having the fragment shader receive a plurality of sets of texture coordinates from the vertex shader, performing a plurality of lookups at different locations within the texture corresponding to the plurality of the sets of the texture coordinates received from the vertex shader, and making at least one comparison among values gathered from the plurality of the lookups and at least one statistical calculation using the values gathered from the plurality of the lookups, and wherein encoding the preliminary data into the plurality of encoded fragments in the frame buffer at each corresponding fragment position further comprises writing the preliminary data directly into the plurality of encoded fragments in the frame buffer at each corresponding fragment position using at least one available color component of a configuration of the frame buffer in one pass.

5. The method of claim 1, wherein reading the plurality of encoded fragments from the frame buffer using the host application further comprises capturing the plurality of encoded fragments from the frame buffer into a main memory using the host application, and wherein calculating the per-frame image statistics desired for the scene image in the frame of the real-time visual simulation using the host application further comprises visiting each of the captured plurality of encoded fragments in a loop and analyzing at least one available color component in each iteration of the loop, tracking and storing any variables needed for whole image analysis, and calculating the per-frame image statistics desired for the scene image in the frame of the real-time visual simulation by producing a set of statistics that pertain to the whole image of the scene image in the frame of the real-time visual simulation.

6. The method of claim 2, wherein reading the plurality of encoded fragments from the frame buffer using the host application further comprises capturing the plurality of encoded fragments from the frame buffer into a main memory using the host application, and wherein calculating the per-frame image statistics desired for the scene image in the frame of the real-time visual simulation using the host application further comprises visiting each of the captured plurality of encoded fragments in a loop and analyzing at least one available color component in each iteration of the loop, tracking and storing any variables needed for whole image analysis, and calculating the per-frame image statistics desired for the scene image in the frame of the real-time visual simulation by producing a set of statistics that pertain to the whole image of the scene image in the frame of the real-time visual simulation.

7. The method of claim 3, wherein reading the plurality of encoded fragments from the frame buffer using the host application further comprises capturing the plurality of encoded fragments from the frame buffer into a main memory using the host application, and wherein calculating the per-frame image statistics desired for the scene image in the frame of the real-time visual simulation using the host application further comprises visiting each of the captured plurality of encoded fragments in a loop and analyzing at least one available color component in each iteration of the loop, tracking and storing any variables needed for whole image analysis, and calculating the per-frame image statistics desired for the scene image in the frame of the real-time visual simulation by producing a set of statistics that pertain to the whole image of the scene image in the frame of the real-time visual simulation.

8. The method of claim 4, wherein reading the plurality of encoded fragments from the frame buffer using the host application further comprises capturing the plurality of encoded fragments from the frame buffer into a main memory using the host application, and wherein calculating the per-frame image statistics desired for the scene image in the frame of the real-time visual simulation using the host application further comprises visiting each of the captured plurality of encoded fragments in a loop and analyzing at least one available color component in each iteration of the loop, tracking and storing any variables needed for whole image analysis, and calculating the per-frame image statistics desired for the scene image in the frame of the real-time visual simulation by producing a set of statistics that pertain to the whole image of the scene image in the frame of the real-time visual simulation.

9. A computer system capable of gathering per-frame image statistics in a real-time visual simulation, the computer system comprising:
a memory operable to store a plurality of frames of the real-time visual simulation; and
a processor coupled to the memory and operable to:
render a scene image in a frame of the real-time visual simulation with contents of a frame buffer copied to a texture comprising a plurality of texels;
reduce resolution of the texture comprising the plurality of the texels using a vertex shader producing a reduced resolution texture of the scene image;
collect preliminary data on each texel of the reduced resolution texture of the scene image using a fragment shader operating on a respective fragment;
encode the preliminary data into a plurality of encoded fragments in the frame buffer at each corresponding fragment position;
read the plurality of encoded fragments from the frame buffer using a host application; and
calculate the per-frame image statistics desired for the scene image in the frame of the real-time visual simulation using the host application.

10. The computer system of claim 9, wherein rendering the scene image in the frame of the real-time visual simulation with contents of the frame buffer copied to the texture comprising the plurality of texels further comprises applying the texture to a polygon quad capable of being captured and processed by the host application, and wherein reducing the resolution of the texture comprising the plurality of texels using the vertex shader producing the reduced resolution texture of the scene image further comprises calculating texture coordinates within the vertex shader as if the texture were separated into a plurality of sections, allowing the fragment shader to perform a plurality of different lookups into the texture for each fragment of the reduced resolution texture of the scene image as if each section of the plurality of sections were a separate image layer of the reduced resolution texture of the scene image.

11. The computer system of claim 9, wherein collecting the preliminary data on each texel of the reduced resolution texture using the fragment shader further comprises having the fragment shader receive a plurality of sets of texture coordinates from the vertex shader, performing a plurality of lookups at different locations within the texture corresponding to the plurality of the sets of the texture coordinates received from the vertex shader, and making at least one comparison among values gathered from the plurality of the lookups and at least one statistical calculation using the values gathered from the plurality of the lookups, and wherein encoding the preliminary data into the plurality of encoded fragments in the frame buffer at each corresponding fragment position further comprises writing the preliminary data directly into the plurality of encoded fragments in the frame buffer at each corresponding fragment position using at least one available color component of a configuration of the frame buffer in one pass.

12. The computer system of claim 10, wherein collecting the preliminary data on each texel of the reduced resolution texture using the fragment shader further comprises having the fragment shader receive a plurality of sets of texture coordinates from the vertex shader, performing a plurality of lookups at different locations within the texture corresponding to the plurality of the sets of the texture coordinates received from the vertex shader, and making at least one comparison among values gathered from the plurality of the lookups and at least one statistical calculation using the values gathered from the plurality of the lookups, and wherein encoding the preliminary data into the plurality of encoded fragments in the frame buffer at each corresponding fragment position further comprises writing the preliminary data directly into the plurality of encoded fragments in the frame buffer at each corresponding fragment position using at least one available color component of a configuration of the frame buffer in one pass.

13. The computer system of claim 9, wherein reading the plurality of encoded fragments from the frame buffer using the host application further comprises capturing the plurality of encoded fragments from the frame buffer into the at least one memory using the host application, and wherein calculating the per-frame image statistics desired for the scene image in the frame of the real-time visual simulation using the host application further comprises visiting each of the captured plurality of encoded fragments in a loop and analyzing at least one available color component in each iteration of the loop, tracking and storing any variables needed for whole image analysis, and calculating the per-frame image statistics desired for the scene image in the frame of the real-time visual simulation by producing a set of statistics that pertain to the whole image of the scene image in the frame of the real-time visual simulation.

14. The computer system of claim 10, wherein reading the plurality of encoded fragments from the frame buffer using the host application further comprises capturing the plurality of encoded fragments from the frame buffer into the at least one memory using the host application, and wherein calculating the per-frame image statistics desired for the scene image in the frame of the real-time visual simulation using the host application further comprises visiting each of the captured plurality of encoded fragments in a loop and analyzing at least one available color component in each iteration of the loop, tracking and storing any variables needed for whole image analysis, and calculating the per-frame image statistics desired for the scene image in the frame of the real-time visual simulation by producing a set of statistics that pertain to the whole image of the scene image in the frame of the real-time visual simulation.

15. The computer system of claim 11, wherein reading the plurality of encoded fragments from the frame buffer using the host application further comprises capturing the plurality of encoded fragments from the frame buffer into the at least one memory using the host application, and wherein calculating the per-frame image statistics desired for the scene image in the frame of the real-time visual simulation using the host application further comprises visiting each of the captured plurality of encoded fragments in a loop and analyzing at least one available color component in each iteration of the loop, tracking and storing any variables needed for whole image analysis, and calculating the per-frame image statistics desired for the scene image in the frame of the real-time visual simulation by producing a set of statistics that pertain to the whole image of the scene image in the frame of the real-time visual simulation.

16. The computer system of claim 12, wherein reading the plurality of encoded fragments from the frame buffer using the host application further comprises capturing the plurality of encoded fragments from the frame buffer into the at least one memory using the host application, and wherein calculating the per-frame image statistics desired for the scene image in the frame of the real-time visual simulation using the host application further comprises visiting each of the captured plurality of encoded fragments in a loop and analyzing at least one available color component in each iteration of the loop, tracking and storing any variables needed for whole image analysis, and calculating the per-frame image statistics desired for the scene image in the frame of the real-time visual simulation by producing a set of statistics that pertain to the whole image of the scene image in the frame of the real-time visual simulation.

17. A method for gathering per-frame image statistics in a real-time visual simulation, the method comprising:
rendering a scene image in a frame of the real-time visual simulation with contents of a frame buffer copied to a texture comprising a plurality of texels;
reducing resolution of the texture comprising the plurality of the texels using a vertex shader producing a reduced resolution texture of the scene image;
collecting preliminary data on each texel of the reduced resolution texture of the scene image using a fragment shader operating on a respective fragment;
encoding the preliminary data into a plurality of encoded fragments in the frame buffer at each corresponding fragment position;
writing the preliminary data directly into the plurality of encoded fragments in the frame buffer at each corresponding fragment position using at least one available color component of a configuration of the frame buffer in one pass;
reading the plurality of encoded fragments from the frame buffer using a host application; and
calculating the per-frame image statistics desired for the scene image in the frame of the real-time visual simulation using the host application.

18. The method of claim 17, wherein rendering the scene image in the frame of the real-time visual simulation with contents of the frame buffer copied to the texture comprising the plurality of texels further comprises applying the texture to a polygon quad capable of being captured and processed by the host application, and wherein reducing the resolution of the texture comprising the plurality of texels using the vertex shader producing the reduced resolution texture of the scene image further comprises calculating texture coordinates within the vertex shader as if the texture were separated into a plurality of sections, allowing the fragment shader to perform a plurality of different lookups into the texture for each fragment of the reduced resolution texture of the scene image as if each section of the plurality of sections were a separate image layer of the reduced resolution texture of the scene image.

19. The method of claim 18, wherein collecting the preliminary data on each texel of the reduced resolution texture using the fragment shader further comprises having the fragment shader receive a plurality of sets of texture coordinates from the vertex shader, performing a plurality of lookups at different locations within the texture corresponding to the plurality of the sets of the texture coordinates received from the vertex shader, and making at least one comparison among values gathered from the plurality of the lookups and at least one statistical calculation using the values gathered from the plurality of the lookups, and wherein writing the preliminary data comprises writing the preliminary data directly into the plurality of encoded fragments in the frame buffer at each corresponding fragment position using at least three available color components of the configuration of the frame buffer in one pass.

20. The method of claim 19, wherein reading the plurality of encoded fragments from the frame buffer using the host application further comprises capturing the plurality of encoded fragments from the frame buffer into a main memory using the host application, and wherein calculating the per-frame image statistics desired for the scene image in the frame of the real-time visual simulation using the host application further comprises visiting each of the captured plurality of encoded fragments in a loop and analyzing at least one available color component in each iteration of the loop, tracking and storing any variables needed for whole image analysis, and calculating the per-frame image statistics desired for the scene image in the frame of the real-time visual simulation by producing a set of statistics that pertain to the whole image of the scene image in the frame of the real-time visual simulation.
